(19) United States
(12) Patent Application Publication
(10) Pub. No.: US 2003/0159212 A1
(43) Pub. Date: Aug. 28, 2003

(54) Pneumatic support and transfer system for bed patients

(76) Inventors: James E. Patrick, Darien, IL (US); Jose L. Cortes, Chicago, IL (US)

Correspondence Address: ICE MILLER, ONE AMERICAN SQUARE, BOX 82001, INDIANAPOLIS, IN, 46282, US

(21) Appl. No.: 10/080,903

(22) Filed: Feb. 25, 2002

(51) Int. Cl. A61G 7/10; A47C 27/08

(52) U.S. Cl. 5/81.1 R; 5/713

(57) ABSTRACT

A pneumatic support and transfer system particularly useful for transferring morbidly obese patients from one location such as a hospital bed to another location such as a stretcher includes a specially constructed air mattress having a soft yet stable cradle formed by a peripheral air chamber which is in continuous communication with open ended passages formed by separate fluid impervious surface panels which maintain the top and bottom surfaces of the mattress out of contact with one another when the mattress is pressurized.

This application pertains to a support and transfer system for bed patients. It is particularly directed to the support and transference of bariatric patients using pneumatic means.

### BACKGROUND OF THE INVENTION

Non-ambulatory patients who must be supported and moved in a patient facility such as a hospital or a nursing home present substantial challenges when a course of treatment for such patients calls for movement from one location to another. A patient may, for example, need to be moved from a hospital bed, which must remain in the patient's room, to a stretcher and then from the stretcher to a treatment location such as a surgical table in an operating room. Following treatment the reverse patient handling sequence must occur; i.e.: the patient must be moved from the surgical table, which remains in the operating room, to a stretcher which travels to the patient's hospital room, and then from the stretcher back onto the bed in the hospital room.

In a very large percentage of such occurrences the patient must be handled in a fashion which requires only a minimum of movement of the patient with respect to his supporting surface. In the case of a patient being returned to his hospital room following surgery, for example, the patient's body may not be able to withstand the stresses and strains of being lifted from a stretcher to the bed when one or even several hospital personnel combine their efforts to make such a transfer.

The same challenge of moving a patient with minimum handling exists in non-surgical settings as well. The bariatric patient is a prime and very common example. When such a patient is categorized as morbidly obese transfers present difficulties for both the patient and the care facility staff. While no exact definition of morbid obesity is universally recognized, many hospitals and other treatment facilities consider a person who weighs about 350 pounds or more to fall within that definition.

Movement of a morbidly obese person often requires the hospital staff to physically lift and/or slide the patient from his at rest position on a hospital bed to an at rest position on a stretcher a total of four times to complete a single treatment cycle, such as surgery. The staff must perform the task of lifting and/or sliding such a patient because in nearly all instances the patient, due to his physical condition of obesity and/or illness, simply cannot do the task himself. The manipulation of such a person requires a plurality of hospital staff since such manipulation is impossible to perform by a single person such as a floor nurse assigned to the patient's room. As a consequence such transfers must be planned in advance for a specific time and a number of hospital staff must be notified and arrange their schedules so that all staff will be available at the exact same time whereby the task, which may take only a few minutes once the manpower is available, can be carried out in a timely fashion. As is well known many hospital staff are females and many of these persons are rather slight of stature including persons who may weigh only a few pounds above 100 pounds. As a result a half dozen or more such persons may need to be assembled. Instances have been known in which a morbidly obese patient has required twelve persons to effect the transfer of such a patient. Gathering together such a large number of people four times at often uncertain intervals to provide but a single cycle of treatment to a patient raises obvious logistical problems and, in addition, erodes the quality of care the facility can render by reason of the application of such a large number of personnel to deal with but a single patient treatment episode.

A further drawback to such a patient handling system as above described is that, even with the best intentioned and caring of staff, the patient very often suffers substantial discomfort. The simple act of sliding a patient over a flat surface can be very painful to a patient who has had surgical incisions which are far from healed, for example.

An attempt has been made to overcome the above described problems by the use of an air mattress onto which the patient is placed while in his bed and which is then placed onto a stretcher. A problem common to all such devices however is that invariably the air mattress has the general characteristic of a balloon in the sense that when one area is indented another remote area will bulge, thus creating an unstable condition. If for example a stretcher carrying an obese person makes a sharp turn during a trip to or from a treatment location, such an obese person will tend to roll toward the outside of the turn due to the instability of such a conventional mattress. The more the patient rolls, the more that that portion of the edge of the mattress toward which the rolling movement occurs will depress, and the greater will be the expansion of the mattress on the other side of the patient. In effect, the conventional mattress reinforces the undesirable rolling movement and hence can be termed to be unstable. Since much of the time the patient is incapable of stopping the rolling action by himself the patient may roll off the stretcher onto the floor with disastrous consequences. Indeed, even in the instance of a patient who is capable of moving himself to some degree about his longitudinal body axis the same disastrous result may occur because the displacement of air from one edge portion of the mattress to the opposite edge portion creates in effect a tipping cradle. Only if the patient lies perfectly flat and perfectly still on the stretcher, and no roadway depressions or blocking objects, such as excess hospital beds stored in a hallway, are encountered can the probabilities of an accident be lessened.

### SUMMARY OF THE INVENTION

The invention is, firstly, a body support structure which can be placed under a hospital or other treatment facility patient easily by a minimum of staff personnel and which then supports the patient on a soft but substantially non-deformable surface having a cradle-like contour at all times during movement onto a stretcher, transference to a treatment locale, return and removal of the patient therefrom. Secondly, the invention includes a method of moving a patient, and particularly a morbidly obese patient, swiftly and safely from an initial location such as a hospital bed to a treatment location, and return, which eliminates the possibility of patient distress at any time during the movement cycle.

### DESCRIPTION OF THE DRAWING

The invention is illustrated more or less diagrammatically in the accompanying drawing wherein

FIG. 1 diagrammatically illustrates the placement of the pneumatic mattress of this invention under a patient, such as a morbidly obese patient, preparatory to transfer of said patient to a treatment locale;

FIG. 2 diagrammatically illustrates the patient on the pneumatic mattress with the pneumatic system activated prior to transference of the patient to a stretcher;

FIG. 3 diagrammatically illustrates the patient after transference from his hospital bed to the stretcher preparatory to start of the travel of the patient to a treatment locale;

FIG. 4 is a perspective view of the pneumatic support structure with parts broken away for clarity and illustrating particularly the internal chambers formed as fluid is being supplied to the structure;

FIG. 5 is a perspective bottom view of the pneumatic support structure of FIG. 4;

FIG. 6 is a side elevation of the pneumatic support structure in an activated condition;

FIG. 7 is a partial top view with parts broken away for clarity; and

FIG. 8 is a perspective view of the pneumatic support structure in combination with an anti-cross contamination system.

### DESCRIPTION OF A SPECIFIC EMBODIMENT

In the following description of a specific embodiment like reference numerals will be used to refer to like or similar parts from Figure to Figure of the drawing.

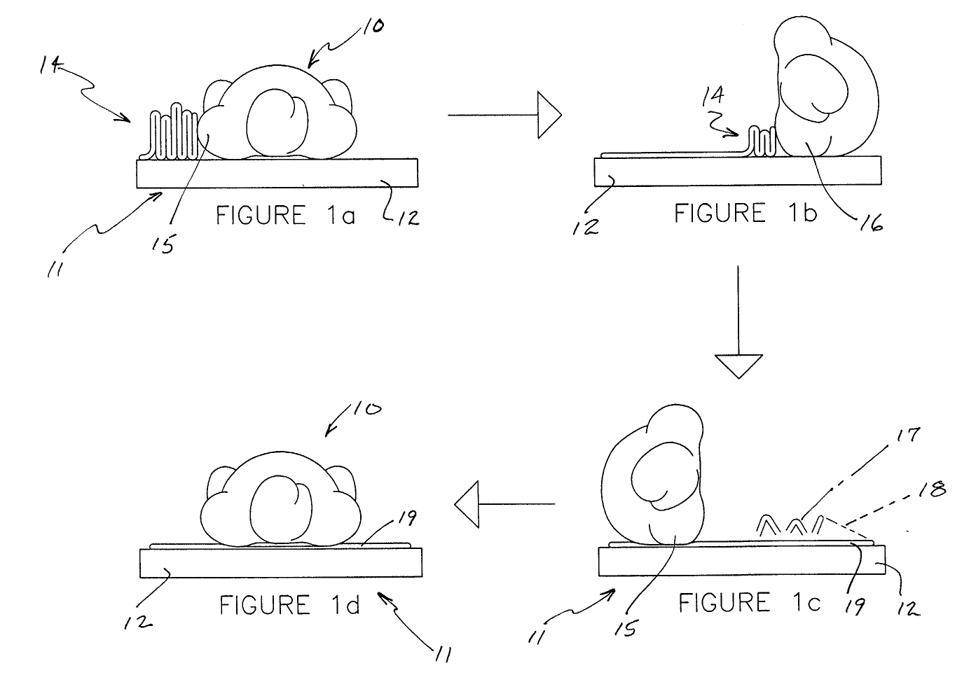

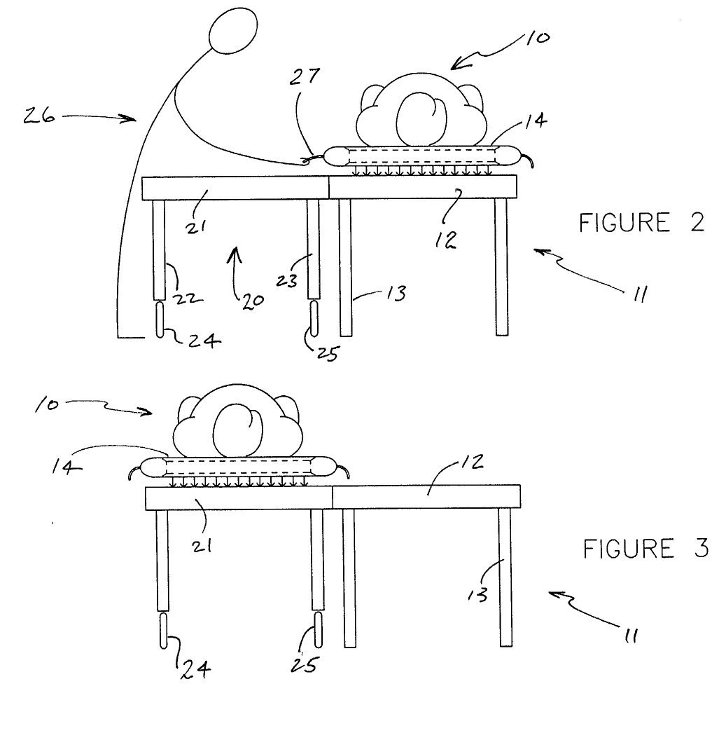

Referring first to FIGS. 1-3 a patient is indicated generally at 10. In FIGS. 1 and 2 the patient 10 is shown on a bed, here a hospital bed, indicated generally at 11. In FIGS. 2 and 3 the bed 11 is seen to have a mattress 12 and legs 13, which legs are not intended to make the bed into a stretcher even though they may have conventional wheels for repositioning the bed within the hospital room.

The method aspect of the invention can be visualized from viewing the FIG. sequence 1a, 1b, 1c, 1d, 2 and 3. In FIG. 1a the patient 10 is shown lying on his bed 11 just prior to the procedure of transferring him from bed 11 to a stretcher. In this Figure the patient is lying on the center portion of bed mattress 12 and the pneumatic support structure of this invention, indicated generally at 14, is shown in an gathered condition extending the length of bed 11 and tucked or nestled snugly along the patient's left side. The pneumatic support structure 14, which is in effect a generally rectangular bag of flexible material which is capable of being expanded upon the application of pneumatic pressure, is shown in this FIG. 1a, and also FIGS. 1b, 1c and 1d, in an unactivated condition. In its unactivated condition it can be crumpled upon itself in accordion fashion to form a floppy, easily manipulated and body conformable bundle. The thickness of the pneumatic support structure has been exaggerated in FIG. 1 for purposes of illustration and clarity. It will be understood that it is more sheet-like in nature than would appear from FIG. 1 and may, in fact, be tucked under the left side of patient 10 which lies above bed mattress 12, namely the patient's left shoulder 15, his left chest, left hip and left leg.

In FIG. 1b the patient 10 with or without the assistance of one or two nurses or other staff personnel has been rolled about 90° clockwise onto his right shoulder 16 momentarily, and the collapsed pneumatic support structure 14 extended rightwardly over bed mattress 12 until the remainder of said support structure which is not in surface abutting contact with the top of bed mattress 12 is tucked or nestled under the right shoulder 16 of the patient.

In FIG. 1c the patient has been rolled either by himself or with the assistance of one or two nurses onto his left shoulder 15 and the balance of his left side and the pneumatic support structure 14 pulled out from its crumpled condition, indicated by discontinuous and dotted lines 17, 18, to its fully extended position indicated at 19.

In FIG. 1d the patient has been rolled about 90° clockwise from his FIG. 1c position until he lies flat in the center of his bed mattress 12 and on the fully extended but collapsed pneumatic support structure 14.

It will be understood that a morbidly obese person has been here illustrated. It will also be understood that less effort is required to merely roll such a person from his back to his side or vice-versa than is required to slide such a person laterally from his bed onto another adjacent surface; indeed one or at most two persons, even women of small stature, can attend to rolling the patient the quarter turns illustrated in the Figure.

Referring now to FIG. 2 a conventional stretcher for transporting a patient is indicated generally at 20, said stretcher having a top 21 and legs 22 and 23 which terminate in wheels 24, 25 respectively. An attendant, such as a nurse or orderly, is indicated generally at 26.

In FIG. 2 the pneumatic support mattress 14 has been activated in a manner which will be described in detail hereafter. Suffice to say that the mattress has been expanded by pumping air into it until it reaches its fully expanded condition and levitated position of FIG. 2. In addition to the expansion of the mattress 14 some of the compressed air passes out of the bottom of the mattress to form a cushion of air 25 beneath the mattress, the cushion of air functioning as an air bearing between the mattress and its support structure. The attendant 26 is shown grasping one or more handles 27 which are stitched or otherwise suitably secured to the long sides of mattress 14 preparatory to moving the patient to the stretcher 20.

In FIG. 3 the attendant has pulled the patient 10 on the mattress transversely to the left as viewed in the Figures to move the patient and the pneumatic mattress 14 from hospital bed 11 onto the stretcher 20. The cushion of air which passes outwardly from the bottom of the mattress 14 and downwardly toward the top surface of, initially, bed 11 and then stretcher 20, functions as a lubricant with a nearly zero coefficient of friction between the underside of mattress 14 and the top surface of bed 11 and stretcher 20.

It will be understood that the above described procedure will be repeated in reverse sequence after the patient has been moved to his destination, such as a surgery room or body treatment center, and then the two procedures are repeated at the conclusion of the journey to return the patient to his bed as indicated in FIG. 1a. Of special note is the fact that because of the cushion of air between the mattress 14 and its several supporting surfaces only a slight effort is needed to move the patient laterally as indicated in FIGS. 2 and 3. Indeed, even a person of small stature who may weigh only approximately 100 pounds or a little more can move a morbidly obese person thus eliminating the need for a number of persons, such as six or more, to meet at a specific time to transfer a patient. Further, since the patient's body does not make sliding contact with the bed mattress 12 and transfer mattress 14, pain to the patient derived from skidding the patient's body over a supporting surface having a substantial coefficient of friction is eliminated.

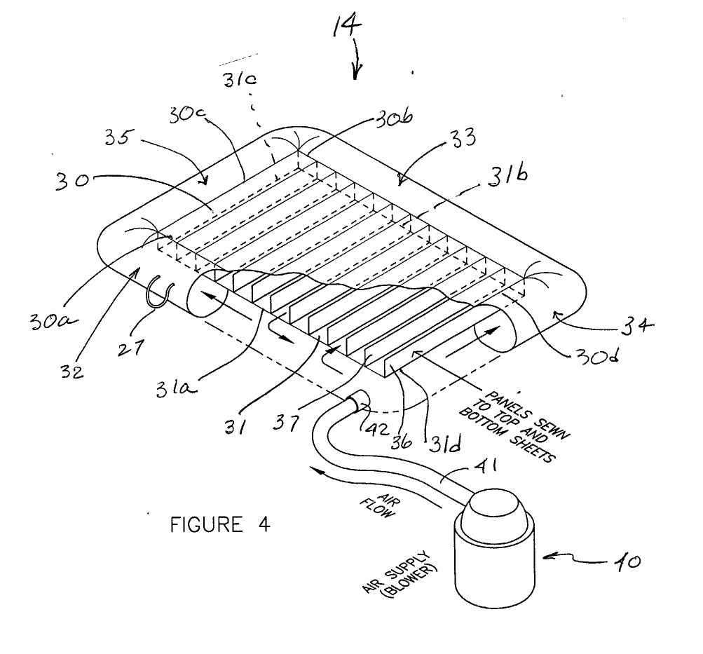

The constructional details of the transfer mattress 14 and its stable cradling features are shown best in FIGS. 4-7.

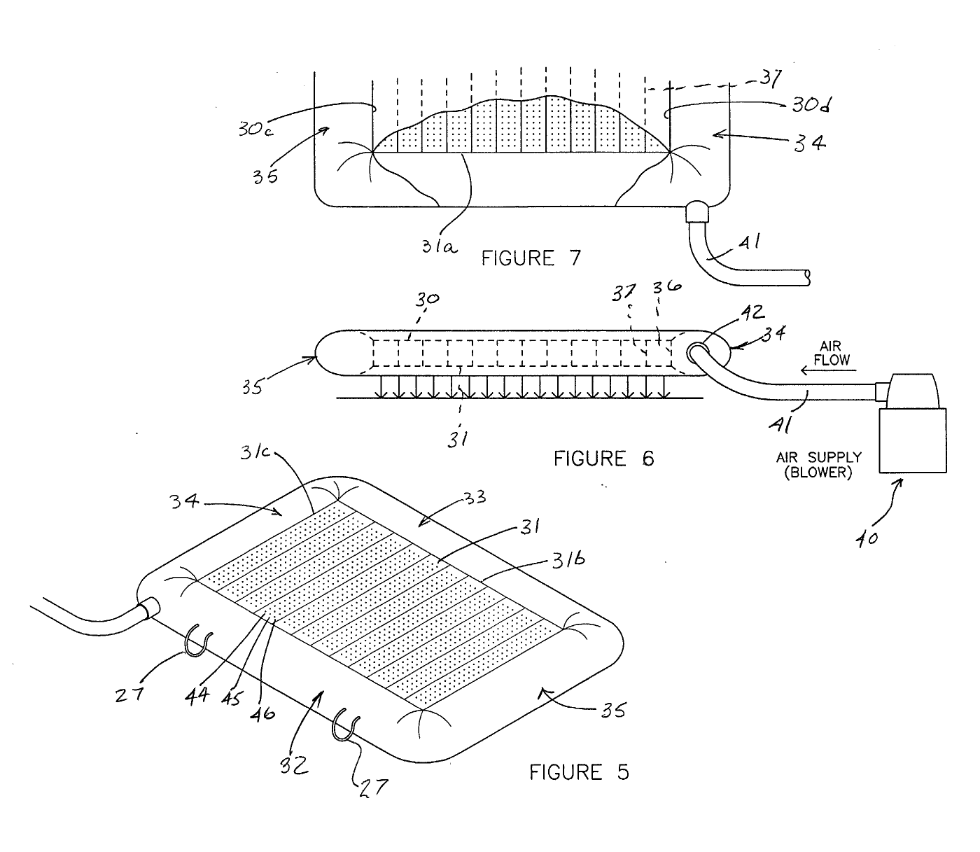

Referring initially to FIGS. 4 and 5 the mattress 14 consists of a top sheet 30, which has been partially broken away in FIG. 4, and a bottom sheet 31, shown best in FIG. 5. The long sides of the top and bottom sheets 30 and 31 are connected to left and right longitudinal side air chambers, indicated generally at 32 and 33, respectively, at 30a, 30b and 31a, 31b, and the short sides of the top and bottom sheets are connected to head and foot end air chambers, indicated generally at 34, 35 respectively, at 30c, 30d, see FIG. 5, and 31c, 31d, see FIG. 5. From FIGS. 4 and 5 and the dotted lines in FIG. 6 it will be seen that the plane of both the top and bottom sheets are located beneath the upper and lower surfaces of the air chambers 32-35. The expanded configuration shown in FIGS. 4 and 5 thus forms a levitated deformation resistant cradle within which the patient is nestled.

The interior of mattress 14, and specifically that portion lying between the outline contour of the top and bottom sheets, functions, in cooperation with the side and end air chambers, to form a stable patient cradle which represents a significant improvement over earlier air mattresses. Specifically a plurality of vertical panels 36, 37, etc. are sewn or otherwise suitably secured to the top and bottom sheets 30, 31 so that when the mattress is charged with a suitable fluid under pressure, such as air, the top and bottom sheets 30 and 31 will be spaced from one another at all times. The panels 36, 37 terminate approximately at the junction between the sheets and the air chambers as seen best in FIG. 4. A source of pressurized air such as a conventional vacuum cleaner blower is indicated generally at 40, the blower having an air flow tube or conduit 41 extending therefrom which is secured to a short sleeve connector 42 which in turn projects out of the left side air chamber 32, here near the air chamber 34. It will thus be seen that when the blower 40 is activated high pressure air will flow freely nearly simultaneously into the four air chambers 32-35 and also between the unobstructed open passageways 38, 39 formed between adjusted panels 36, 37, etc.

The improvement represented by the spacing of the top and bottom sheets 30, 31 by means of the stitched seams 36, 37 is that a rigidity is provided to the structure which would not be present if the top and bottom sheets 30 and 31 were not connected to one another, or otherwise arranged to be spaced from one another along linear seams in a manner analogous to tufting. In such a prior construction the side toward which a patient rolls tends to flatten to a dangerous degree since the pressure in the side air chamber is the only pressure which resists the weight of the patient. With the present construction however the entire side portion of the sheet toward which a patient's weight rolls acts to resist the patients weight as well as the air pressure in the side chambers. The result is that while the patient is provided with a soft, deformable supporting surface at all times, the supporting surface retains its contour even if the patient inadvertently rolls to one side; in effect the cradle-like contour is stabilized which dramatically increases the safety of the patient while continuously providing a soft and comfortable support.

Referring now specifically to FIGS. 5 and 6 the operation of the lubricating or air bearing cushion of air is there seen best. The bottom sheet 31 has a plurality of vents or holes, three of which are indicated at 44, 45, 46, which permit the pressurized air in the air chambers and between the sheets 30, 31 to bleed away. The number of vents and the size of each vent must be such that the mattress 14 will be levitated above whatever supporting surface lies beneath it at all times. In other words, the size and number of the vent holes when considered in relation to the power of the fluid pressure supply must be such as to maintain sufficient pressure in the mattress as will support a load, such as a patient, above and out of contact with the supporting surface at all times during activation. FIG. 6 illustrates more or less diagrammatically the mattress in an activated, levitated position, even if a patient is lying thereon. In one embodiment in which a conventional Sears Roebuck consumer type vacuum cleaner blower was used as the air supply, satisfactory results were achieved with vents or holes 4446 of approximately 1/128th of an inch in diameter arranged 9 to the square inch. It will be understood that in the usual practice the blower will operate only during the transfer of a patient from one support structure to another since that is the only period when potentially painful, and difficult, disturbance of the patient will occur.

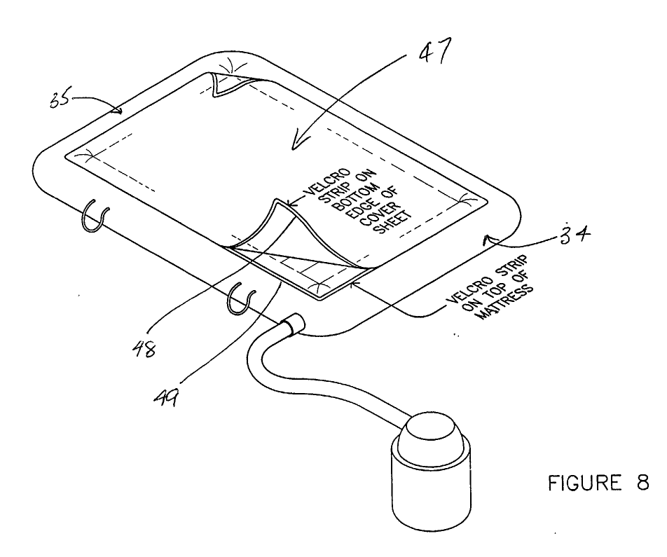

The cross-contamination feature of the invention is illustrated in FIG. 8. As is well known, discharges from patients' bodies can be quite infectious and hence all patient facilities require that all equipment be maintained in as sterile a condition as possible. Since the mattress 14 may be used to serve one or more additional patients following a first use of the day the potential for exposing subsequent patients to non-sterile conditions is obvious. In this case however the sterile integrity of the system is maintained by the use of a contamination prevention sheet indicated generally at 47 in FIG. 8 which overlies the mattress 14 and has substantially the same contour. The underside of the sheet has a strip of suitable sheet-to-sheet connector along its perimeter. Here a strip of Velcro is illustrated at 48. Another strip of Velcro on mattress 14 is indicated at 49, the two Velcro strips being in vertical alignment when the cross-contamination sheet is aligned with and placed on the mattress 14, said Velcro strips forming means for connecting the sheet to the mattress. Preferably the contamination prevention sheet 47 is disposable and thus a new sheet may be placed on the inflated mattress immediately after a patient has been removed from the mattress so that the pneumatic support system will be in sterile readiness for use by the next patient.

It will thus be seen that a simple, inexpensive yet efficient patient transfer system which meets sanitary requirements has been provided. The pressurized fluid mattress component of the system has the attribute of a soft and comfortable support for a patient while maintaining a rather rigid, i.e.: stable, configuration which maximizes the safety of the patient while providing virtually pain free patient manipulation.

Although the present invention has been described in detail with reference to a specific embodiment, one skilled in the art will appreciate that the present invention can be practiced by other than the above described embodiment. Accordingly it is intended that the scope of the invention not be limited by the foregoing exemplary description, but rather solely by the scope of the hereafter appended claims when interpreted in light of the relevant prior art.

I claim:

1. In a method of pneumatically supporting and transferring bed patients the steps of
placing an inactivated pneumatic transfer mattress under a bed patient without rolling the patient more than about 90° in either direction from a lay flat position,
activating the pneumatic transfer mattress by admittance of pressurized pneumatic fluid thereto to thereby form a soft yet deformation resistant cradle which maintains its cradle configuration substantially unchanged when the patient moves toward the edges thereof,
forming a cushion of pressurized pneumatic fluid between the bottom of the mattress and its supporting surface to thereby levitate the patient and the mattress above the supporting surface, and
transferring the mattress with the patient on it from a first surface to a second supporting surface while maintaining a cushion of pressurized pneumatic fluid between the bottom of the mattress and those portions of the supporting surfaces which vertically underlie the mattress.

2. The method of claim 2 characterized in that
the levitated mattress with the patient on it is transferred from the first surface to the second surface by application of a transfer force applied to the mattress in a direction toward the second surface.

3. The method of claim 2 further characterized in that
the levitated mattress with the patient on it is pulled by hand applied forces only from the first surface to the second surface.

4. The method of claim 3 further characterized in that
the hand applied forces are derived from no more than two persons.

5. The method of claim 4 further characterized in that
the bed patient is morbidly obese.

6. The method of claim 5 further characterized in that
the pneumatic fluid is air.

7. In combination in a pneumatic support and transfer system
a pneumatic transfer mattress,
said mattress having side and end chambers which surround an interior space,
said mattress further having a top sheet and a bottom sheet whose outer edges connect to the chambers which surround them,
means for admitting pneumatic fluid to the surrounding chambers, means for securing the top and bottom sheets to one another to form defined passages between opposed chambers after pneumatic fluid has been admitted to the chambers in the absence of a load on the sheets,
said chambers and the defined passages between the top and bottom sheets being in free flow fluid transfer relationship to one another at all times, and
means for levitating the mattress above a supporting surface during the time pressurized fluid is being admitted to the mattress.

8. The pneumatic support and transfer system of claim 7 further characterized in that
the means for maintaining the top and bottom sheets in fixed spaced relationship to one another consists of
a plurality of seam lines which extend substantially across the interior area formed by the surrounding chambers,
said space lines forming defined but unobstructed fluid flow passages between the chambers in the passages defined by the same lines,
whereby a load placed on any location above the top sheet will be supported by pressurized fluid at all locations there beneath.

9. The pneumatic support and transfer system of claim 8 further characterized in that the
means for levitating the mattress above a supporting surface incudes
vent holes in the bottom sheet which enable pressurized fluid in the interior of the mattress to bleed downwardly from the bottom sheet at a rate which enables sufficient fluid pressure to be maintained within the mattress when a patient load is placed on the top sheet to support the load.

10. The pneumatic support and transfer mattress of claim 9 further including
first means for connecting a cross-contamination sheet to the top of the mattress,
said first connecting means being located on the peripheral portion of the mattress,
a cross-contamination prevention sheet of a contour which substantially overlies the mattress, and
second means for connecting the cross-contamination sheet to the mattress,
said second connecting means being located on the underside of the cross-contamination sheet.

11. The pneumatic support transfer mattress of claim 10 further characterized in that
the first and second connecting means are Velcro connectors.

12. The pneumatic support and transfer mattress of claim 11 further characterized in that
the cross-contamination prevention sheet is a single use sheet.
